(19) United States
(12) Patent Application Publication
(10) Pub. No.: US 2005/0097001 A1
(43) Pub. Date: May 5, 2005

(54) System, method, device, and program for supporting provision of customer service, portable terminal device

(75) Inventor: Junichi Iijima, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/947,342

(22) Filed: Sep. 23, 2004

Related U.S. Application Data
(63) Continuation of application No. PCT/JP02/03171, filed on Mar. 29, 2002.

(51) Int. Cl. G06F 17/60

(52) U.S. Cl. 705/26

(57) ABSTRACT

There is provided a customer service support system for supporting provision of customer service to be offered by a person offering customer service, comprising: a medium capable of being carried by a customer and also intended to record customer specifying information for specifying the customer; customer information recording section; customer specifying information read-out section; customer information acquisition section for acquiring, from the customer information recording section, the customer information on the customer, on the basis of the customer specifying information read-out by customer information read-out section; a display section; a display control section for effecting a control allowing the display section to display the customer information acquired, whereby it is made possible to support provision of customer service to be offered by a person offering customer service, and it is made possible also to improve increase in satisfaction of the customers.

### TECHNICAL FIELD

The present invention relates to a system, a method, a device, and a program for supporting provision of customer service, a portable terminal device, suitably applicable for supporting provision of customer service by a salesperson in customer service areas such as e.g. the shops and the like.

### BACKGROUND ART

Hitherto there is a method, adopted by salespersons, for offering customer service to customers who came to the shop such that in general the salespersons watch the shop interior (or sales floor interior), and then on recognizing the customers who came to the shop, some of the salespersons, capable of offering customer service, offers customer service to the customers.

Further, there is a conventional method of management of information on customers, executed in such a manner that e.g. a purchase record is to be kept in the form of a record of customer card. As a consequence salespersons offer customer service to customers without acquiring in advance any customer information on the customers (purchase history and the like), on occasion of offering customer service to the customers, whereby they by all means rely on their own memories (experience of customer service) in carrying out customer service. As the case may be, the customer card is, according to the need, employed at the time of the settlement to confirm the purchase history.

However, since in the conventional method of offering customer service it is impossible to acquire information on a customer (e.g. purchase history and the like) prior to the offering of customer service, there is the difficulty in grasping exactly purchase history and the like on occasion of the offering of customer service. Therefore, in the case where in the shop with a plurality of salespersons available, for each visit of the shop, different salespersons offer customer service to the same customer, it can be considered that there are repeated invitations or offering of the same merchandise or undesirable merchandise many times to customers, although the customers pay a visit to the shop many times, with the result that the customers have dissatisfying feeling, whereby there arises the problem of being unable to improve increase in satisfaction of customers as well as complicated circumstances.

Additionally, since conventionally salespersons only watch the shop interior in between times while working, and consequently leave customers as they are, without recognizing that customers came to the shop, there is a fear of causing dissatisfaction of the customers or also missing sales opportunities.

In view of the above problems the present invention has been devised, and an object of the invention is to provide a system, a method, a device, and a program for supporting provision of customer service, a portable terminal device, for supporting provision of customer service in customer service areas, allowing to devise the invention to notify, prior to the offering of customer service, a person offering customer service of customer information on the pertinent customer so as to support provision of customer service to be offered by a person offering customer service and also improve an increase in satisfaction of customers.

### DISCLOSURE OF THE INVENTION

To achieve the foregoing object according to the present invention there is to provide a customer service support system for supporting provision of customer service to be offered by a person offering customer service in customer service areas, comprising: a medium capable of being carried by a customer and also intended to record customer specifying information for specifying the customer; customer information recording section capable of recording customer information on the customer; customer specifying information read-out section capable of reading-out the customer specifying information; customer information acquisition section for acquiring, from the customer information recording section, the customer information on the customer, on the basis of the customer specifying information read-out by customer information read-out section; a display section for displaying the customer information acquired by the customer information acquisition section; a display control section for effecting a control allowing the display section to display the customer information acquired by the customer information acquisition section.

Further, there may be provided, in the vicinity of the entrance of the customer service areas, the customer specifying information read-out section, which is intended to read out information recorded in the medium to be carried by the customer making entry into the customer service areas, and further there is provided a notifying section which, on reading out customer specifying information, notifies the person offering customer service of the customer having made entry into the customer service areas.

Furthermore it may be provided that in the case where a plurality of customers are staying in the customer service area, the display control section is adapted to effect a control allowing the display section to display the list of at least part of customer information associated with the customers specified by the customer specifying information from the customer specifying read-out section, from among the plurality of customers staying within the customer service area, and further there may be provided a selecting section for allowing the person offering customer service to select customers to be subjected to customer service in association with the customer information from among the customers displayed in the list.

Still further it may be provided that there is provided a priority setting section for setting priority with which said plurality of customers are to be subjected to a customer service for each person offering customer service, and further the display control section is adapted to effect a control allowing the display section to display said customer information in accordance with the priority set by the priority setting section.

Herein the medium may be a contactless integrated circuit card; and the customer information may be at least a name of customer and purchase history; and the customer information may incorporate a face photo of customer. The medium may function as the customer information recording section.

Additionally there may be provided customer service support method of supporting provision of customer service to be offered by a person offering customer service in customer service areas, comprising the steps of: a step of recording customer information on the customer; a step of reading-out the customer specifying information from the medium intended to record customer specifying information for specifying the customer; a step of customer information acquisition for acquiring said customer information on the customer recorded in the step of recording customer information, on the basis of the customer specifying information read-out in the customer specifying information read-out step; a display step of displaying the customer information acquired in the customer information acquisition step.

Herein the step of reading-out the customer specifying information may comprise reading-out the customer specifying information recorded in the medium to be carried by a customer making entry into customer service areas in the vicinity of the entrance of the customer service areas and further there may be provided a notifying step of notifying the person offering customer service of the customer having made entry into customer service areas, on the occasion of the reading-out of the customer specifying information in the step of reading-out the customer specifying information.

Herein the display step may comprise displaying, in case of a plurality of customers staying in the customer service area, the list of at least part of customer information, associated with the customers specified by the customer specifying information in the step of read-out the customer specifying information, from among the plurality of customers staying within the customer service area, and further there may be provided a selecting step of allowing the person offering customer service to select customers to be subjected to customer service in association with the pertinent customer information to be selected from among the customer information displayed in the list.

Further for a plurality of customers there may be provided the step of setting priority with which said plurality of customers are to be subjected to customer service for each person offering customer service, and further the display step may comprise displaying the list of the customer information in accordance with the priority set in the priority setting.

Further the medium may be a contactless integrated circuit card; and the customer information may be at least a name of customer and purchase history; and the customer information may incorporate a face photo of customer; and the step of recording customer information customer may comprise recording information on the customer in the medium.

Furthermore there may be provided customer service support device for supporting provision of customer service to be offered by a person offering customer service in customer service areas, comprising: customer information recording section capable of recording customer information on the customer; customer information acquisition section for acquiring the customer information on the customer, on the basis of the customer specifying information for specifying the customer read-out from the medium capable of being carried by a customer; a display control section for providing a control allowing the display section to display the customer information acquired by the customer information acquisition section.

Further there may be provided a notifying section which, on occasion of entry of the customer into customer service areas, notifies the person offering customer service of the entry, having been made by the customer, into the customer service areas.

Still further in the case where a plurality of customers are staying in the customer service area, the display control section may be adapted to effect a control allowing the display section to display the list of at least part of customer information associated with the customers specified by the customer specifying information, from among the plurality of customers staying within the customer service area.

Furthermore for a plurality of customers there may be provided a priority setting section for setting priority with which said plurality of customers are to be subjected to a customer service for each person offering customer service, and further the display control section is adapted to effect a control allowing the display section to display, in accordance with the priority set by the priority setting section, the list of said customer information.

Herein the medium may be a contactless integrated circuit card; the customer information may be at least a name of customer and purchase history; and the customer information may incorporate a face photo of customer.

Furthermore there may be provided a customer service support program causing a computer to execute a function of supporting customer service to be offered by a person offering customer service in customer service areas, said program causing a computer to function as the following sections, and said sections comprising: customer information acquisition section for acquiring, the customer information on the customer from the customer information recording section, on the basis of the customer specifying information read-out from the medium capable of being carried by the customer; a display control section for effecting a control allowing the display section to display the customer information acquired by the customer information acquisition section.

Herein the program may cause a computer to function as a notifying section, which, on occasion of the entry, having been made by the customer, into customer service areas, notifies the person offering customer service of the customer having made entry into the customer service areas.

Further, in the case where a plurality of customers are staying in the customer service area, the display control section may be adapted to effect a control allowing the display section to display the list of at least part of customer information associated with the plurality of customers staying within the customer service area.

Furthermore there may be provided a priority setting section for setting priority with which said plurality of customers are to be subjected to a customer service for each person offering customer service, and further the display control section is adapted to effect a control allowing the display section to display, in accordance with the priority set by the priority setting section, customer information by listing said customer information.

Herein the medium may be a contactless integrated circuit card; the customer information may be at least a name of customer and purchase history; and the customer information may incorporate a face photo of customer.

Incidentally the computer-readable medium according to the present invention is the one in which the above-mentioned customer service support program is recorded.

Furthermore there is provided portable terminal device for supporting provision of customer service to be offered by a person offering customer service in customer service areas, comprising: a receiving means for receiving customer information on the customer; a display means for displaying customer information; a display control means for effecting a control allowing the display section to display the customer information received by the receiving means. Here, on occasion of entry of the customer into customer service areas the receiving means may be intended to receive content to the effect pertaining thereto.

Herein the display control means may be adapted to effect a control allowing the display section to display the list of at least part of customer information associated with the plurality of customers; and the display control section may be adapted to effect a control allowing the display section to display the list of the customer information, in accordance with the set priority, with which the customers are to be subjected to a customer service, for each person offering customer service.

Herein the customer information may be at least a name of customer and purchase history; the customer information may incorporate a face photo of customer.

As stated above a system, a method, a device, and a program for supporting provision of customer service, a portable terminal device can provide following effects or advantages:
(1) By reading-out the customer specifying information from a medium for recording customer specifying information for specifying the customer and acquiring the customer information, recorded in advance, on the customer, on the basis of the customer specifying information and then displaying it, it is made possible for the person offering customer service to have an access to customer information on the customer, so as to enable the offering of customer service corresponding to the customer, prior to the offering of customer service so that there is achieved a great convenience as well as improved increase in satisfaction of customers.
(2) By reading out information recorded in the medium to be carried by the customer making entry into the customer service areas in the vicinity of the entrance of the customer service area and, on occasion of the reading out of customer specifying information, notifying the person offering customer service of the customer having made entry into the customer service areas, it is made possible for the person offering customer service to quickly acquire knowledge of the customer having made entry into the customer service areas, so that there is achieved a great convenience.
(3) By allowing to display the list of at least part of customer information associated with the customers, in the case where a plurality of customers are staying in the customer service area, it is facilitated that the person offering customer service grasp circumstances concerned with the plurality of customers staying in the customer service area.
(4) By allowing the person offering customer service to select customers to be subjected to customer service in association with the customer information from among the customers displayed in the list and to have an access to the customer information, it is made possible for the person offering customer service to readily acquire knowledge of the customer information, so that there is achieved a great convenience.
(5) By setting priority with which said plurality of customers are to be subjected to a customer service and allowing the display section to display the customer information as the list in accordance with the priority set by the priority setting section, it is made possible for the person offering customer service to readily acquire knowledge of the customer with high priority, so as to enable the quick offering of customer service to the customer with high priority, so that there is achieved a great convenience as well as improved increase in satisfaction of customers with high priority.
(6) By employing a contactless integrated circuit card as the medium, it is made possible to read-out readily information recorded on the medium (customer specifying information) so that there is achieved a great convenience.
(7) By employing at least a name of customer and purchase history as customer information, it is made possible for the person offering customer service to acquire knowledge of at least a name of customer and purchase history prior to the offering of customer service, so as to enable the offering of customer service corresponding to the customer, so that there is achieved a great convenience as well as improved increase in satisfaction of customers.
(8) By incorporating a face photo in the customer information, it is made possible for the person offering customer service to confirm the face of the customer prior to the offering of customer service, whereby also there is achieved a great convenience as well as improved increase in satisfaction of customers.
(9) By recording customer information onto the medium, it is made possible to employ the medium as customer information recording section, so as to enable the simplification of the system as well as the reduction of system cost and operating cost. Further it is also made possible to share those customer information with other systems provided independent of the present system, whereby there is achieved a great convenience.

### BRIEF DESCRIPTION OF THE DRAWINGS

FIG. 1 is a schematic block diagram showing a customer service support system according to one embodiment of the present invention.

FIG. 2 is a schematic block diagram showing the structure of the customer card in the customer service support system according to one embodiment of the present invention.

FIG. 3 is a schematic block diagram showing the structure of the portable terminal in the customer service support system according to one embodiment of the present invention.

FIG. 4 is a block diagram for explaining the structure of the portable terminal in the customer service support system according to one embodiment of the present invention.

FIGS. 5(a) to (c) is a schematic block diagram showing respectively the structure of the data to be recorded in the customer database in the customer service support system according to one embodiment of the present invention.

FIG. 6 is a block diagram showing an example of the structure of the extracted customer information in the customer DB in the customer service support system according to one embodiment of the present invention.

FIG. 7 to FIG. 11 are views showing an example of a display screen (customer service support screen) of the touch panel of the portable terminal in the customer service support system according to one embodiment of the present invention.

FIG. 12 to FIG. 14 show examples of screen for the list of customers to be displayed on the touch panel of the portable terminal in the customer service support system according to one embodiment of the present invention.

FIG. 15 is a flowchart for explaining the processing at the time of the customer's visit of the shop in the customer service support system according to one embodiment of the present invention.

FIG. 16 is a flowchart for explaining the method by which salespersons are to have access to information customers in the customer service support system according to one embodiment of the present invention.

FIG. 17 is a flowchart for explaining the processing in case of executing settlement processing at the POS terminal in the customer service support system according to one embodiment of the present invention.

FIG. 18 is a flowchart for explaining the processing at the time of the customer's going away from the shop in the customer service support system according to one embodiment of the present invention.

### BEST MODES FOR CARRYING OUT THE INVENTION

### BEST MODE FOR CARRYING OUT THE INVENTION

Embodiments of the present invention will be described below with reference to the drawings.

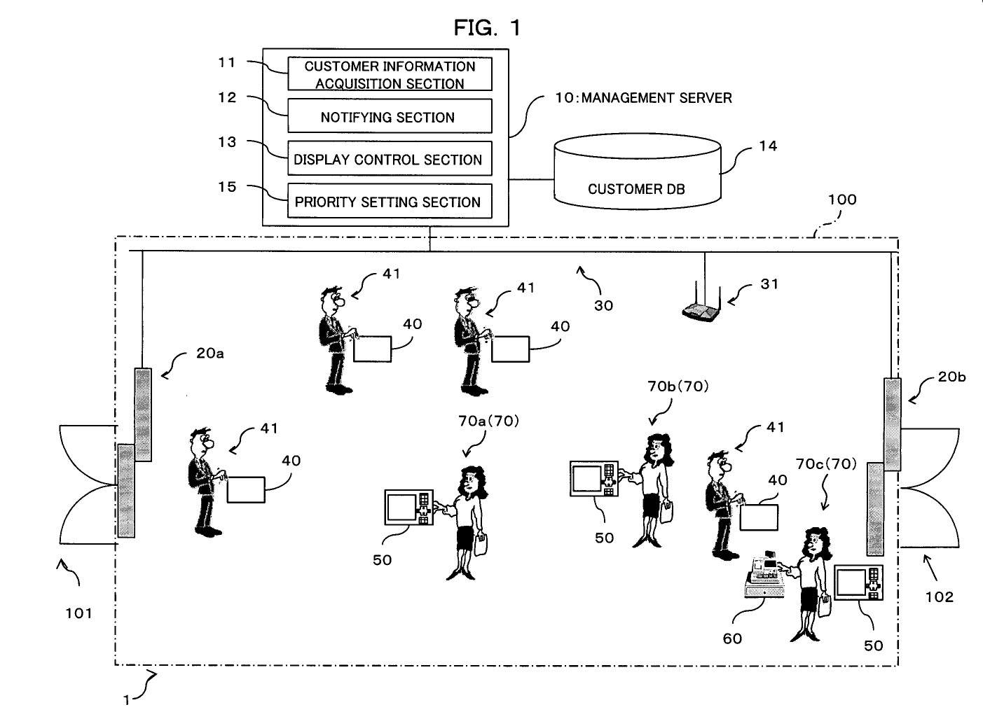

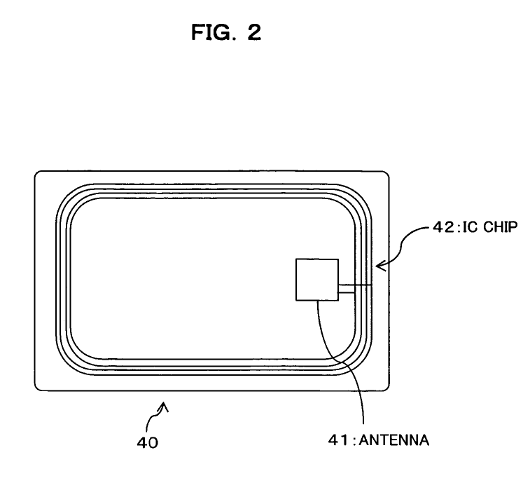

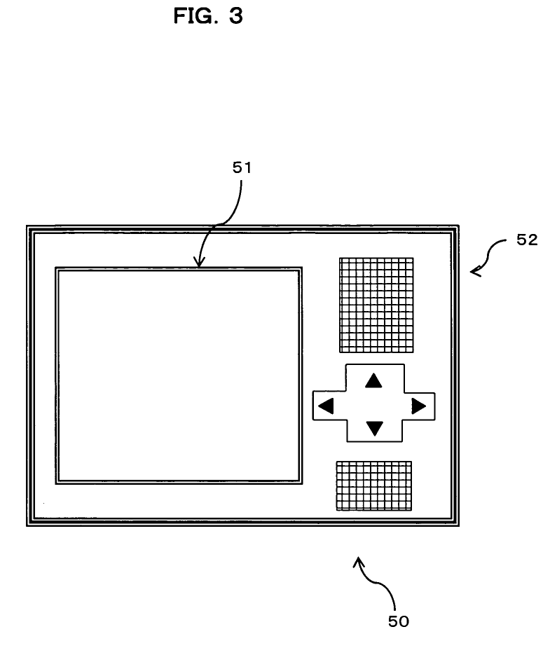

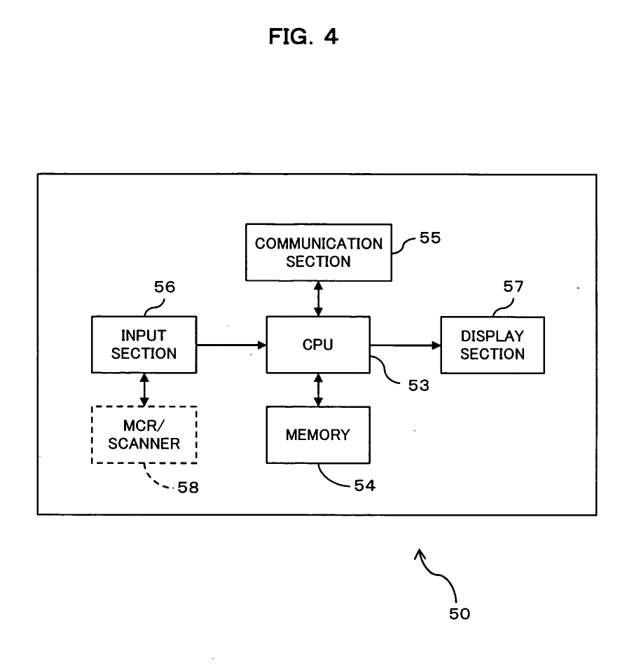

FIG. 1 is a schematic block diagram showing a customer service support system according to one embodiment of the present invention. FIG. 2 is a schematic block diagram showing the structure of the customer card in the customer service support system according to one embodiment of the present invention. FIG. 3 is a schematic block diagram showing the structure of the portable terminal in the customer service support system according to one embodiment of the present invention. FIG. 4 is a block diagram for explaining the structure of the portable terminal in the customer service support system according to one embodiment of the present invention.

The present customer service support system 1 is adapted to support provision of customer service to a customer 41 to be offered by a salesperson (a person offering customer service) 70 (70a, 70b, 70c) in the shop 100 (customer service areas) and is comprised of a management server (customer information acquisition section 11, a notifying section 12, a display control section 13, a priority setting section 15) 10, customer DB 14, card gate (customer information read-out section) 20, communication network 30, customer card(medium) 40, portable terminal(portable terminal device, display section, selecting section) 50 and POS terminal 60.

Here in FIG. 1 there is shown an example which in the shop 100 three customers 41 are staying, and three salespersons 70a, 70b and 70c are staying. As for donations, hereinafter in use, of salespersons, when one out of a plurality of salespersons needs to be specified, a reference numeral 70a, 70b or 70c is employed, however, when anyone out of a plurality of salespersons is to be denoted, a reference numeral 70 is employed.

A customer card 40 is a contactless type IC (Integrated Circuit) card intended to record customer specifying information adapted to specify customer 41 and capable of being carried by a customer 41. Incidentally as customer specifying information there is recorded on the customer card 40 a customer code (code of customer) set for each customer 41.

This customer card 40 is, as shown in FIG. 2, provided with an IC chip 41 made up resin and coil antenna 42 embedded therein. The IC chip 41 is microcomputer, miniaturized in the form of IC chip, being comprised of a memory (not shown) for recoding customer code (not shown), transmission/reception circuit (not shown) for carrying out modulation/demodulation for communication and microprocessor (not shown) for carrying out processing such as encryption of information or calculation and the like.

The antenna 42 is shaped helically and is adapted to perform a supply of energy or an exchange of information using radio waves between the card gate 20a, 20b and itself.

The antenna 42 operates as “receiving antenna” and produces induced electromotive force and thereby converts received radio waves into electric energy, so as to drive the above-mentioned IC chip 41. That is to say, in the antenna 42 the coil is excited by external alternating current magnetic field, whereupon the excitation energy (induced voltage) thereof is available in order to drive the afore-mentioned IC chip 41, and moreover to deliver the information of received radio waves to the IC chip 41.

The antenna 42 is adapted to transmit as “transmitting antenna”, the customer codes stored in the IC chip 41 toward the outside of the customer card 40. That is to say, since the IC chip 41 is provided with a memory for storing customer information and a transmission/reception circuit for transmitting as radio signals the customer information toward the outside, only an excitation from the outside allows the IC chip 41 to be driven, whereby it is made possible to transmit the customer codes, even if the customer card 40 is kept held inside the wallet or pocket of the customer.

The card gates (customer information read-out section) 20a, 20b are respectively disposed in such a manner to read-out the customer code stored in the customer card 40, wherein at the entrance 101 the card gate 20a is disposed, while at the exit 102 the card gate 20b is disposed, such that the customers 41 certainly pass by those card gates 20a, 20b at the time of visit of the shop/at the time of the going away therefrom.

As for donations, hereinafter in use, referring to the card gates, when one out of a plurality of the card gates needs to be specified, a reference numeral 20a or 20b is employed, however, when anyone out of a plurality of card gates, is to be denoted, a reference numeral 20 is employed.

Now, when the customers 41 carrying the customer card 40 pass by the card gate 20a disposed at the entrance 101 of the shop 100, the card gate 20a is adapted to read-out the customer code from the customer card 40, and likewise, when the customers 41 carrying the customer card 40 pass by the card gate 20b disposed at the exit 102 of the shop 100, the card gate 20b is adapted to read-out the customer code from the customer card 40 of the customer 41.

The card gate 20 is provided with a transmitting antenna (not shown) for providing contactless power supply to the customers and transmission of information (command and the like) to the customer card 40 as well as a receiving antenna (not shown) for receiving the customer code transmitted from the customer card 40. Here the card gate 20 is communicably connected to the management server 10 by way of communication network 30 and transmits by way of communication network 30 the customer code received from the customer card 40 to the management server 10.

Further the card gate 20 causes the antenna 42 to produce induced electromotive force, by means of radio waves outputted from the transmitting antenna so as to activate the IC chip 41 disposed at the customer card 40, whereupon the customer card 40 returns data of this IC chip 41 from the antenna 42 to the card gate 20.

Here signals received by the receiving antenna of the card gate 20 are transmitted to the management server 10 by way of communication network 30, after the signals have been converted into data to be received available in the present system 1 via filter and demodulator and the like. Note that there may be, according to the need, written specific information (record of the coming to the shop/the going away therefrom and the like).

The portable terminal (portable terminal device) 50 is information processing device capable of being carried by salespersons 70 in the shop 100 and, as shown in FIG. 3, is provided with a touch panel 51 and a keyboard 52. Moreover this portable terminal 50 includes communication section (receiving means) 55(refer to FIG. 4) with radio LAN interface and is communicably connected wirelessly to the management server 10 by way of communication network 30 including wireless LAN (Local Area Network) base station 31. And the portable terminal 50 is adapted to receive notification regarding visit of the shop or customer information (purchase history or family information and the like) to be transmitted from the management server 10, using the communication section 55.

Furthermore in the present embodiment a plurality of salespersons 70 (in case of the present embodiment e.g. three salesperson A (70a); salesperson B (70b); salesperson (70c)) are concerned with the offering of customer service in the shop 100 and each of those salespersons are to carry a dedicated portable terminal 50. Here each salesperson is to be able to have an access to the notification regarding visit of the shop or customer information (purchase history or family information and the like).

Moreover the portable terminal 50 may read-out, via input section 56(refer to FIG. 4), data recorded on a card of magnetic recording type (membership card of customer 41 or identification card of salesperson, 70) by providing MCR (Magnetic Character Reader: Reader Unit for reading-out magnetic record) or scanner 58 externally or in a built-in fashion, so as to execute processing such as settlement, wherein by providing scanner 58 externally or in a built-in fashion it may be made possible to read-out bar-codes formed in a merchandise or the membership card of customer 41, so as to execute processing such as settlement. By the way in this case an interface and the like for connecting the MCR or scanner to the portable terminal 50 is intended to function as an input section 56.

The keyboard 52 is e.g. comprised of ten-key or function key, and is to function as input section (inputting means) 56(refer to FIG. 4), by which the salesperson 70 perform various input operations (or selecting operations). The touch panel 51 is to allow displaying information such as notification regarding visit of the shop of the customer 41 or customer information (purchase history or family information and the like) of the customer 41, or to allow inputting various inputs (or selecting), wherein in addition to the functioning as a display section (displaying means) 57 (refer to FIG. 4) allowing the inputting of various information, the touch panel is to function as an input section (inputting means) 56 (refer to FIG. 4) for inputting various information.

Herein in the present embodiment the salesperson 70 is intended to be able to perform various input operations (or selecting operations) from either of the keyboard 52 or the touch panel 51, whereby it is made possible to perform various input operations using the keyboard 52 or the touch panel 51.

The portable terminal 50 is, as shown in FIG. 4, provided with CPU (Central Processing Unit: unit for central processing) 53, memory 54, communication section 55, input section 56 and display section 57.

The portable terminal 50 is configured to put into action OS (Operating System) or various applications working on OS using CPU 53 and memory 54.

As an example the portable terminal 50 includes respectively applications allowing searching and displaying various information on merchandise (inventory or price), or performing ordering business, or inputting information (registration inputting) on business transactions to be made between the client 41 and itself. Note that information on business transactions is to be transferred to the management server 10 or POS (Point Of Sales) management system not illustrated.

Moreover in the portable terminal 50 CPU 53 is intended to function as the display control section for effecting a control allowing displaying on the touch panel 51(display section 57) customer information received by the communication section 55 by executing the program causing to effect various controls allowing displaying on the touch panel 51.

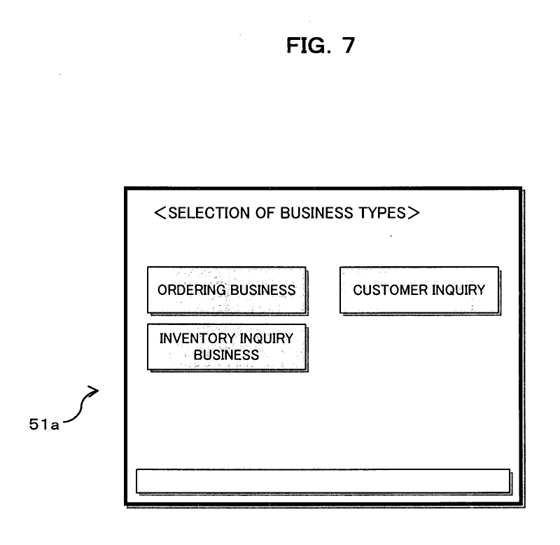

The portable terminal 50 is intended to allow displaying on the touch panel 51 various customer service support screens (refer to FIG. 7 to FIG. 11 and the like; as described hereinafter) to which the salesperson 70 can have access, whereby it is made possible for the salesperson 70 to perform various input operations in connection with various customer service screens displayed on the touch panel 51 using the keyboard 52 or the touch panel 51. Here in the present embodiment as described hereinafter, the management server 10 is to provide various customer service support screens, however the invention is not limited to this, and display servers (web server and the like) not shown may provide those customer service support screens. Or the program registered in advance in the portable terminal 50 may cause to provide those customer service support screens, and various modifications may be executed without departing from the spirit of the invention.

The customer DB (Data Base) 14 is to record a variety of information on the customer 41(customer information) and is intended to function as customer information storing section. Further the customer DB 14 is to be managed by management server 10. Herein the customer DB is to be configured within the computer-readable recording medium (memory, magnetic memory, flexible disk, memory card, magneto-optic memory, and the like) provided at the information processing device (computer; management server 10) in a built-in fashion or externally. Now in the present embodiment, as the customer information there is to be recorded information on the coming to the shop/the going away therefrom, or detailed customer information purchase history or family information and the like.

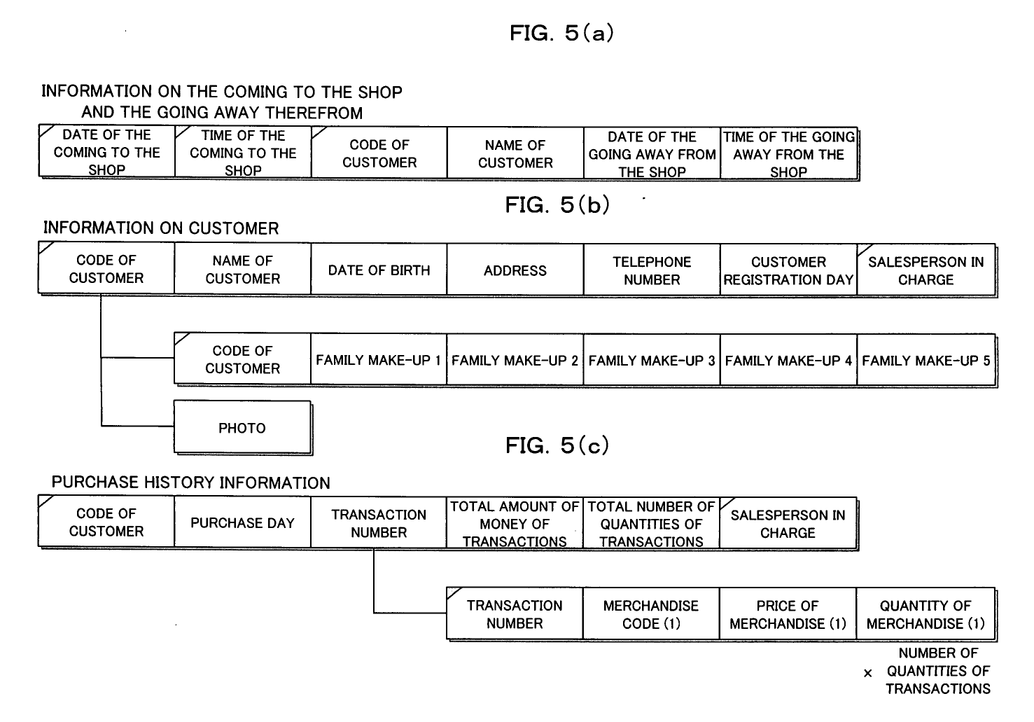

FIGS. 5(a) to (c) is a schematic block diagram showing the structure of the data to be recorded in the customer database 14 in the customer service support system 1 according to one embodiment of the present invention, wherein FIG. 5(a) is a view showing the structure of the data pertaining to the information on the coming to the shop/the going away therefrom, FIG. 5(b) is a view showing the structure of the data pertaining to the detailed customer information and FIG. 5(c) is a view showing the structure of the data pertaining to the purchase history information.

The information on the coming to the shop/the going away therefrom is adapted for keeping record of the date and time when the customer 41 came to the shop 100, as well as date and time when the customer went away from the shop, and is composed, as shown in FIG. 5(a), of date of the coming to the shop, time of the coming to the shop, code of customer, name of customer, date of the going away from the shop, time of the going away from the shop to be formed by recording in association with one another. Note that at date of the coming to the shop, time of the coming to the shop, date of the going away from the shop and time of the going away from the shop there are to be inputted date and time read-out from the customer card 40 of the customer 41 by the card gate 20a and the card gate 20b.

That is to say in the event of the reading-out of the customer code from the customer card 40 by the card gate 20a the management server 10 is intended to create a new record and keep record, as pertinent record of date and time of the coming to the shop, of date and time when the customer code was read-out. Here in the event of creation of a new record the management server 10 is intended to acquire name of customer from the detailed customer information (refer to FIG. 5(b)) on the basis of the customer code read-out, so as to input it. Further in the event of the reading-out of the customer code by the card gate 20b the management server 10 is intended to search the customer DB 14 on the basis of that customer code and keep record, as pertinent record of date and time of the going away from the shop, of date and time when the customer code was read-out in association with a record corresponding to the customer code.

The detailed customer information is adapted for recording detailed information on the customer 41 and is composed, as shown in FIG. 5(b), of data as follows: code of customer, name of customer, date of birth, address, telephone number, customer registration day, salesperson in charge, family make-up (family make-up 1, family make-up 2, family make-up 3, family make-up 4, family make-up 5), photo, to be formed by recording associated with one another.

In the example shown in FIG. 5(b), family make-up 1 to 5 is respectively associated with the customer code, and in association with the family make-up 1 to 5 is recorded respectively information on the family (name, age, etc.) of the customer 41.

The information to be recorded as those detailed customer information are to be registered in advance at the time of new registration of customers and the like.

The purchase history information and the like are adapted for recording purchase history of the customer 41 and there is to be recorded as record information on the business transaction at each time the customer 41 purchases merchandise. The pertinent purchase history information is composed, as shown in FIG. 5(c), of data as follows: customer code, purchase day, transaction number, total amount of money of transactions, total number of quantities of transactions, salesperson in charge, merchandise code, price of merchandise and quantity of merchandise to be formed by recording associated with one another.

In the case where the customer 41 purchase a plurality of merchandise on the same day in the shop 100, total price of merchandise, total quantity of merchandise are to be respectively associated with the plurality of merchandise code and total amount of money of transactions, total number of quantities of transactions and recorded respectively associated with those plurality of merchandise for a given transaction number.

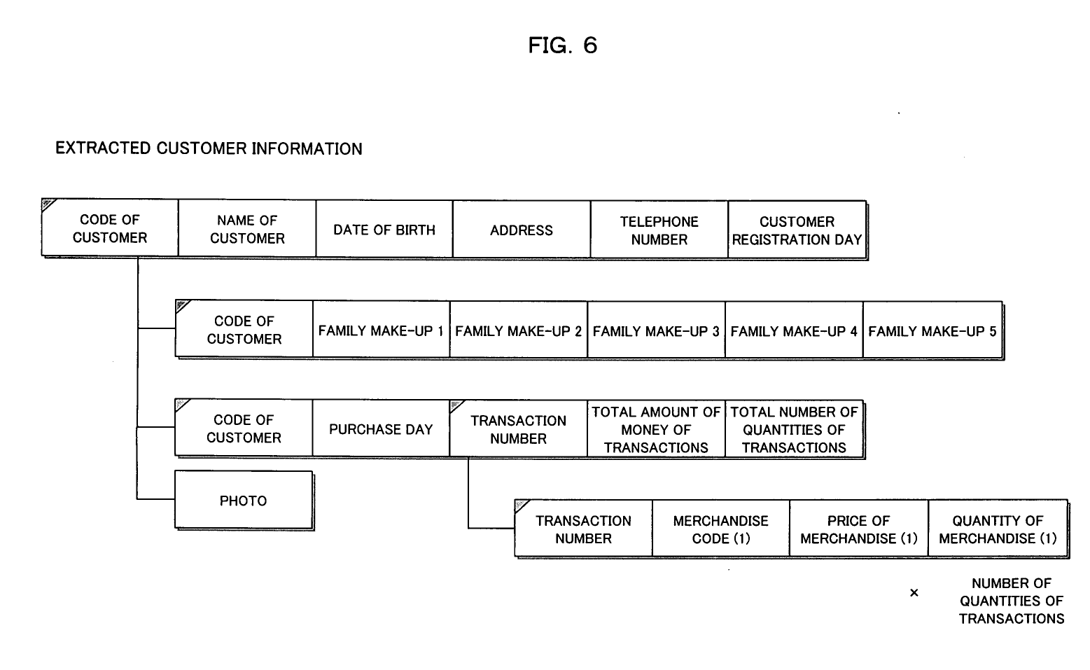

FIG. 6 is a view showing an example of the data structure of the extracted customer information in the customer service support system 1 according to one embodiment of the present invention. This extract customer information is an information created by extracting the customer information shown in FIGS. 5 (a) to (c) on the basis of the customer code of a specific customer 41, wherein the pertinent customer information is to be created by the customer information acquisition section 11.

The management server (customer service support device) 10 is adapted for supporting provision of customer service to be offered to the customer 41 by a salesperson 70 in the shop 100 and is constituted by information processing unit (computer system and the like) provided with CPU (Central Processing Unit) or OS (Operating System).

The CPU of the management server 10 is configured to function, as described hereinafter, as a customer information acquisition section 11, a notifying section 12, a display control section 13 and priority setting section 15 by executing the program stored in the computer-readable medium (e.g. memory, magnetic storing device, flexible disk, memory card, magneto-optic storing device, CD (CD-ROM, CD-R, CD-RW, etc.), DVD(DVD-ROM, DVD-RAM, DVD-R, DVD-RW, DVD+RW, etc.) and the like).

In addition to the management of various data recorded in the customer DB 14 the management server 10 is configured, to execute various processing on the basis of data or demand inputted from portable terminal 50 and has a function of a customer information acquisition section 11, a notifying section 12, a display control section 13 and priority setting section 15.

The customer information acquisition section 11 is adapted for receiving via the communication network 30 the customer code read-out by the card-gate 20a and acquiring the customer information on the customer 41 from the customer DB 14 on the basis of the pertinent customer code. That is to say the customer information acquisition section 11 is adapted for extracting various data recorded in the customer DB 14 associated with the customer code read-out by the card-gate 20a and creating extracted customer information (refer to FIG. 6). Moreover the customer information acquisition section 11 is adapted for deleting the extracted customer information on occasion of the going away of the customer 41 from the shop, namely, on occasion of the reading-out of the customer code by card-gate 20b.

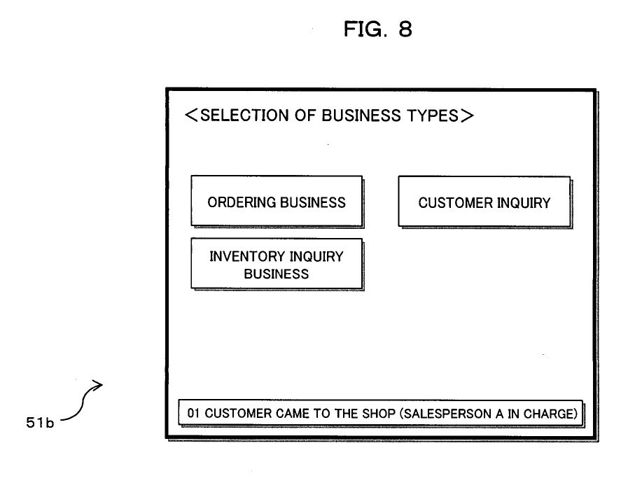

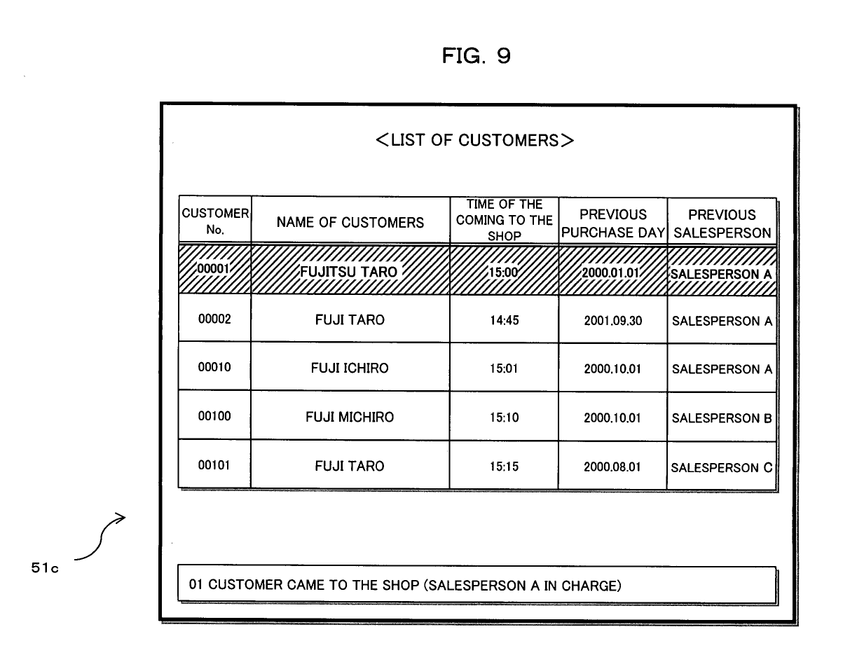

The notifying section 12 is adapted for notifying the salesperson 70 of the entry, having been made by the customer 41, into the interior of the shop 100 (the interior of customer service areas) on occasion of the reading-out of the customer code by card-gate 20a. Specifically the notifying section 12 may cause a display of a notification containing a message on the touch panel 51 of the portable terminal 50 carried by each salesperson 70 regarding the entry, having been made by the customer 41 into the shop 100, wherein the message to be pertaining to be displayed is as follows: “The customer came to the shop” as shown in FIG. 8 and FIG. 9.

This notification may be made such that e.g. from the management server 10(the notifying section 12) e-mail may be transmitted to each portable terminal 50, or other methods other than e-mail may be employed.

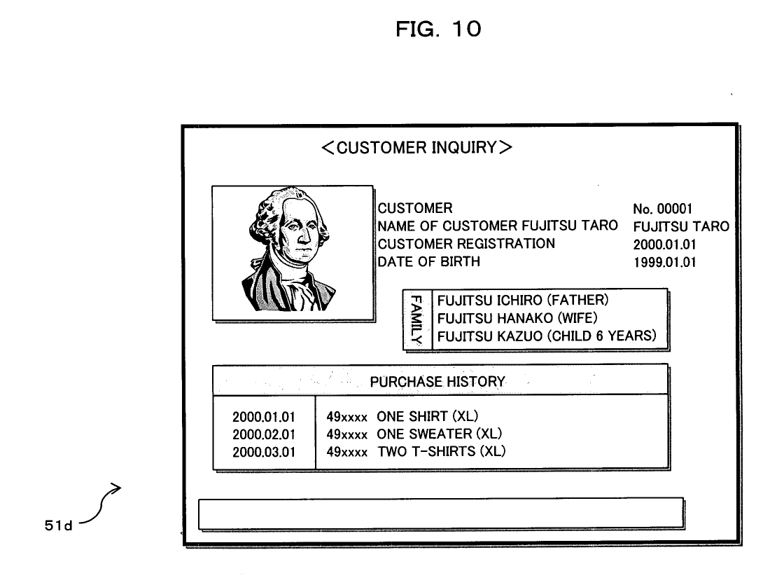

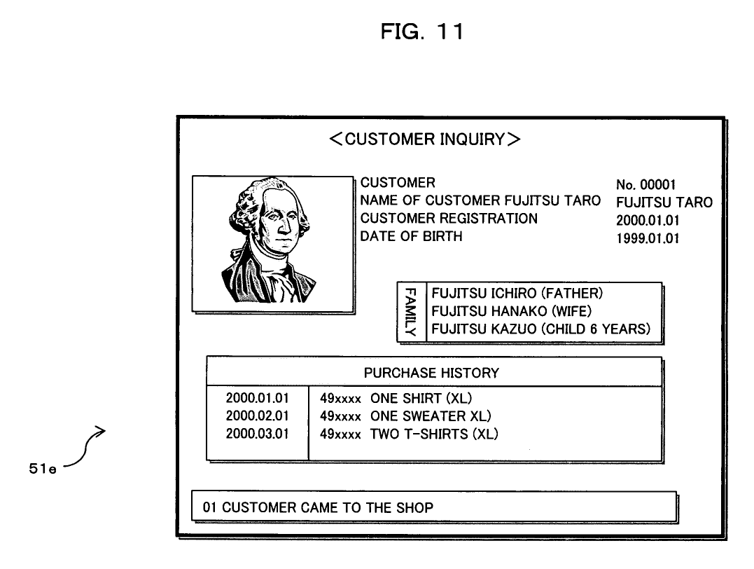

FIG. 7 to FIG. 11 are views showing an example display screen (customer service support screen) of the touch panel 51 of the portable terminal 50 in the customer service support system 1 according to one embodiment of the present invention, wherein FIG. 7 shows an example of a display of selection of business types, FIG. 8 shows an example of a display screen for notification having been made, regarding the customer's visit of the shop in the screen for selection of business types shown in FIG. 7, FIG. 9 shows an example of the display of a screen for displaying the list of the customers, and FIG. 10 and FIG. 11 show respectively an example of a screen for displaying customer inquiry. Here the customer service support screen (51a, 51b, 51c, 51d, 51e) shown in FIG. 7 to FIG. 11 show examples of display screen (customer service support screen) displayed on the touch panel 51 of the portable terminal 50 carried by the salesperson A (salesperson 70a). Herein in the present embodiment as for the customer service support screen (51a to 51e) the management server 10 (the display control section 13) allows the portable terminal 50 to display it.

The display control section 13 is configured to effect a control allowing touch panel 51 of each portable terminal 50 to display customer service support screen. This display control section 13 is configured to allow displaying the screen 51c of the portable terminal 50 for the list of the customers, in the case where a plurality of customers 41 are staying in the shop 100 and it is provided that there is effected a control allowing displaying a row of customer code (customer No.) name, time of the coming to the shop, pervious salesperson, of the customers 41 specified by the customer code read-out by the card gate 20 as shown in FIG. 9.

That is to say it is provided that in the case where a plurality of customers 41 are staying in the shop 100, display control section 13 effects a control allowing the portable terminal 50 (touch panel 51) to display the list (screen for displaying the list of the customers) of at least part of customer information associated with the customers 41 specified by the customer code read-out by the card gate 20, from among the plurality of customers 41 staying within the customer service area.

The screen for the selection of business types (main screen) 51a as shown FIG. 7 is configured to allow the selection of business types by salespersons 70, wherein it is made possible for salespersons 70 to select either of “ordering business”, “customer inquiry business” and “inventory inquiry business”. And usually on the touch panel 51 of the portable terminal 50 the screen for the selection of business types 51a is to be displayed.

Herein “ordering business” is adapted for effecting the ordering of the merchandise, and “inventory inquiry business” is adapted for confirming the inventory. “Customer inquiry business” is adapted for enabling an access to the information on customers 41 staying in the shop 100, whereby a salesperson 70 can select this customer inquiry business so as to enable a screen for displaying the list of the customers as shown in FIG. 9.

In the screen for the selection of business types 51b shown in FIG. 8 there is displayed the notification regarding the visit of the shop at the lower portion of the screen for the selection of business types 51a. The notification regarding the visit of the shop shown in FIG. 8 is adapted for notifying to the effect that the customer 41 to whom customer service is preferentially offered by the salesperson A came to the shop, wherein as shown in FIG. 8 a message “The customer came to the shop” is followed by a message “salesperson A in charge”.

In the customer service support system 1 the management server 10 is adapted for setting a rank of priority of the salesperson 70 intended to offer customer service as described hereinafter, wherein to the notification to be made the salesperson 70 with the highest priority regarding the visit of the shop there should be added the message “salesperson oo in charge”. Here the portion of the message “oo” is to contain information for specifying the salesperson 70 such as name of salesperson and the like.

In the screen for the list of customers shown in FIG. 9 there is to be displayed the list of the customers 41 staying in the shop 100 in accordance with the rank of the priority, as described hereinafter, pertaining to the customers 41 staying in the shop 100. In the present embodiment a customer 41 with highest priority is to be subjected to a customer service preferentially from among the customers 41 displayed in the list. Further in the present embodiment in the screen for displaying the list of customers 41 there are to be displayed customer code (customer No.), name of customer, time of the coming to the shop, previous purchase day, previous salesperson 70. And the salesperson 70 can acquire from the screen for the list of customers 51c readily knowledge of customers 41 staying in the shop 100 and also can acquire readily knowledge of customers 41 to whom he/she is intended to preferentially offer customer service.

When the salesperson 70 selects a specific customer 41 in the screen for the list of customers 51c, the customer inquiry screen 51d is to be displayed as shown in FIG. 10 in connection with the selected customers 41.

In the present embodiment the screen for the list of customers (the customer service support screen) 51c is caused to be displayed on the touch panel 51 of the portable terminal 50, wherein this touch panel 51 (portable terminal 50) is allowed to function as a selecting section enabling selecting customer 41 intended to be subjected to a customer service from among the customers displayed in the list of customer information.

In the customer inquiry screen 51d shown in FIG. 10 detailed information on the customer 41 (customer information) is caused to be displayed, whereby regarding the specific customer 41 there is to be extracted customer information recorded in the afore-mentioned customer DB 14. In the present embodiment there are to be displayed customer No. (customer code), name of customer, customer registration (customer registration date), date of birth, family, purchase history, photo (face photo). The information is to be acquired from the customer DB 14 by the customer information acquisition section 11, whereupon the display control section 13 allows the display on the touch panel 51 of the portable terminal 50.

By causing the customer inquiry screen (customer service support screen) 51d to be displayed on the touch panel 51 of the portable terminal 50 the touch panel 51 (or portable terminal 50) is allowed to function as a display section displaying customer information.

When in the screen for the list of customers (the customer service support screen) 51c the salesperson 70 selects the specific customer 41 and causes the display of the customer inquiry screen 51d, display control section 13 (or notifying section 12) judges that the notification was made to the salesperson 70 and erases the notification message from the touch panel 51.

In the customer inquiry screen 51e shown in FIG. 11 the notification regarding the visit of the shop is displayed at the lower portion of the customer inquiry screen 51e shown in FIG. 10. The notification, shown in FIG. 11, regarding the visit of the shop is adapted for making a notification of the entry, having been made by the customer 41, into the shop 100, the customer 41 being intended to be subjected preferentially to customer service by the salesperson. 70 other than the salesperson A with the highest priority, wherein as shown in FIG. 11 only a message “The customer came to the shop” is to be displayed.

In the customer service support system 1 the management server 10 is adapted for setting a rank of priority of the salesperson 70 intended to offer customer service, wherein to the notification regarding the visit of the shop there should be not added to the salesperson 70 whose priority is other than the highest priority the message “salesperson oo in charge”.

That is to say, in the event of causing the display of the screen 51c for the list of customers the control section 13 allows the touch panel 51 of the portable terminal 50 owned by each person offering customer service 70 to display respective different list, according to the order of priority set by the priority setting section 15.

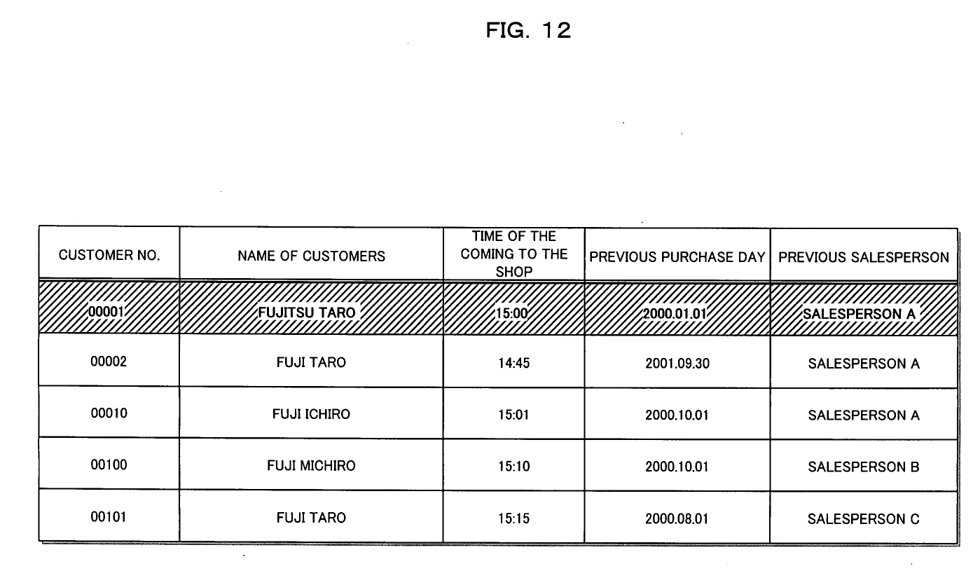

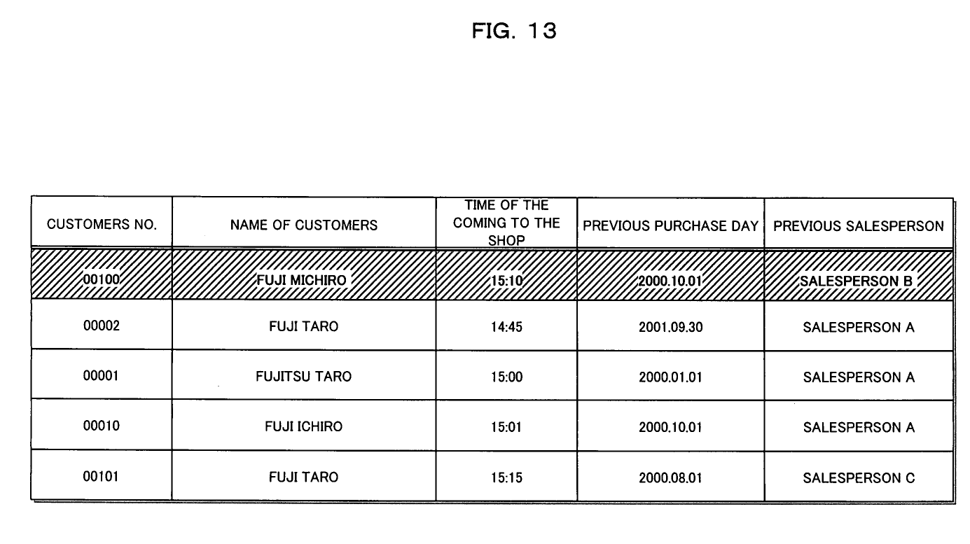

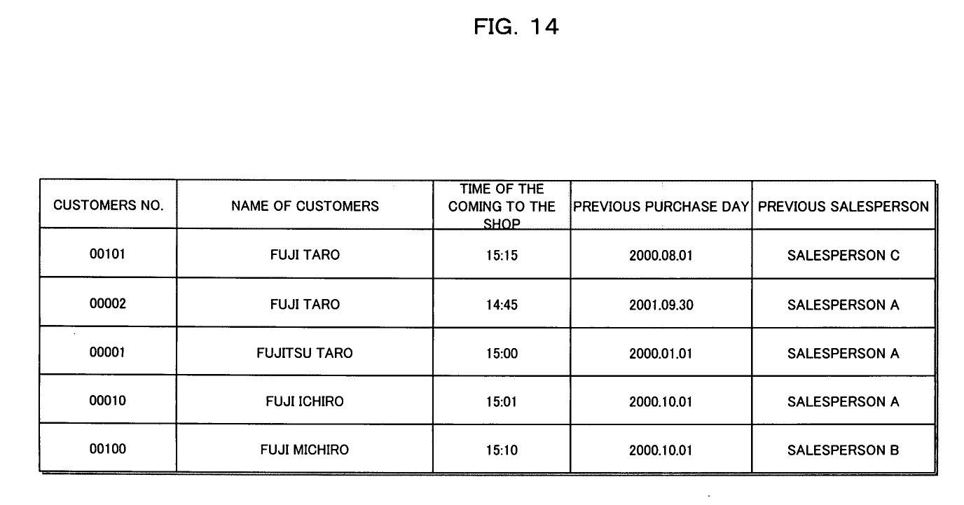

FIG. 12 to FIG. 14 show examples of screen for the list of customers to be displayed on the touch panel 51 of the portable terminal 50 in the customer service support system 1 according to one embodiment of the present invention. FIG. 12 show examples of screen for the list of customers to be displayed on the portable terminal 50 of the salesperson A (salesperson 70a). FIG. 13 shows examples of screen for the list of customers to be displayed on the portable terminal 50 of the salesperson B (salesperson 70b). FIG. 14 shows examples of screen for the list of customers to be displayed on the portable terminal 50 of the salesperson C (salesperson 70c).

The screen for the list of customers shown in FIG. 12 to FIG. 14 show examples of the display to be made at the same time in the shop 100 on the portable terminal 50 carried respectively by a person offering customer service A, a person offering customer service B, a person offering customer service C.

That is to say in the present customer service support system 1 there is to be set for each person offering customer service a different rank or order of priority by the priority setting section 15, so that also screens for the list of customers on the portable terminal 50 are different from one another.

In the case where a plurality of customers 41 are staying in the shop 100 the priority setting section 15 is adapted for setting for each salesperson the priority with which the salesperson is intended to offer customer service. As an example as for a customer, for whom the salesperson 70 did not make any selection the screen for the list of customers 51d (refer to FIG. 9), and no display of the customer inquiry screen 51d (refer to FIG. 10) was performed, the priority setting section 15 is to set his/her priority to the highest rank (hereinafter also referred to as unread customer).

On the other hand as for a customer, for whom the salesperson 70 made some selection in the screen for the list of customers 51c (refer to FIG. 9), and the display of the customer inquiry screen 51d (refer to FIG. 10) was performed (hereinafter also referred to as already read customer), the priority setting section 15 is to set his/her priority such that the rank of priority is to be set e.g. in the order of priority as follows: “previous purchase day is not long after the purchase”; “total amount of sales is large”; “the time of the coming to the shop is late”.

Herein the setting method for priority is not limited to the afore-mentioned, and various modifications are to be executed.

POS terminal 60 is an information processing device for performing settlement for merchandise purchased by the customer 41 in the shop 100 and is constituted as a terminal of a POS system not shown. Further this POS terminal 60 is communicably connected to the management server 10 or OS system and the like by way of the communication network 30 and is adapted for transmitting information (customer code, purchase day, transaction number, merchandise code, price of merchandise, quantity of merchandise, total amount of money of transactions, total number of quantities of transactions, salesperson and the like) on business transactions in which the customer made the settlement for purchased merchandise in the shop 100, which information is to be transmitted to the management server 10 or POS system via communication network 30.

The communication network 30 is adapted for communicably connecting management server 10, portable terminal 50 POS terminal 60 and POS system (not shown) with one another and for transmitting/receiving various data and the like on the basis of protocol such as TCP/IP and the like. Further the communication network 30 has an access point 31. This access point 31 is an access point for wireless LAN (wireless LAN base station) for connecting portable terminal 50 to the communication network 30 and is provided with a wireless antenna and data communication function.

And the wireless interface (communication section 55) and access point 31 is adapted for transmitting/receiving data by means of electromagnetic waves (radio waves) and the like, whereby each portable terminal 50 is to be connected to the communication network 30. Here in the present embodiment for the communication network 30 the portable terminal 50 is to be connected via the wireless LAN system, so that there is no need to connect it to communication network 30 by way of cable, and the portable terminal 50 can be carried by the salesperson 70 in the shop 100 in the state that the portable terminal 50 is communicable with the communication network 30.

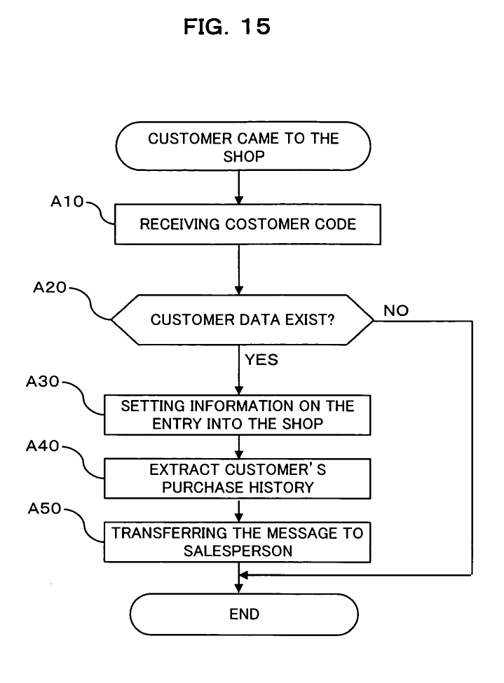

The processing at the time of visit of the customer 41 in the customer service support system 1 as one embodiment of the present invention configured as stated above will be described in reference to the flowchart shown in FIG. 15(steps A 10 to A 50).

The customer 41 carrying the customer card 40 came to the shop 100, whereupon on receipt of the customer code registered in the customer card 40 (step A 10; customer information read-out step) the card gate 20a provided at the entrance 101 transmits the customer code read-out to the management server 10 via the communication network 30. When the customer 41 without the customer card 40 passed by the card gate 20a, the card gate 20a is unable to read-out the customer code of the customer 41.

The management server 10 (customer information acquisition section 11) having received the customer code judges whether there exists the detailed customer information corresponding to the customer code in the customer DB (step A 20), whereupon in case of lack of the detailed customer information (refer to NO route in step A 20) the processing is ended.

On the other hand, in the case where there exists the detailed customer information corresponding to the customer code (refer to YES route in step A 20) in the customer DB 14, the management server 10 creates a record of information on the coming to the shop/the going away therefrom, and inputs in connection with the record date of the coming to the shop, time of the coming to the shop, customer code and name of customer (step A 30).

The customer information acquisition section 11 extracts information on the customer 41 from the purchase history information in the customer DB 14 to create extracted customer information (refer to FIG. 6) (step A 40; customer information acquisition step) and the notifying section 12 notifies the portable terminal 50 of the salesperson 70 of the coming of the customer 41 to the shop (step A 50; notifying step).

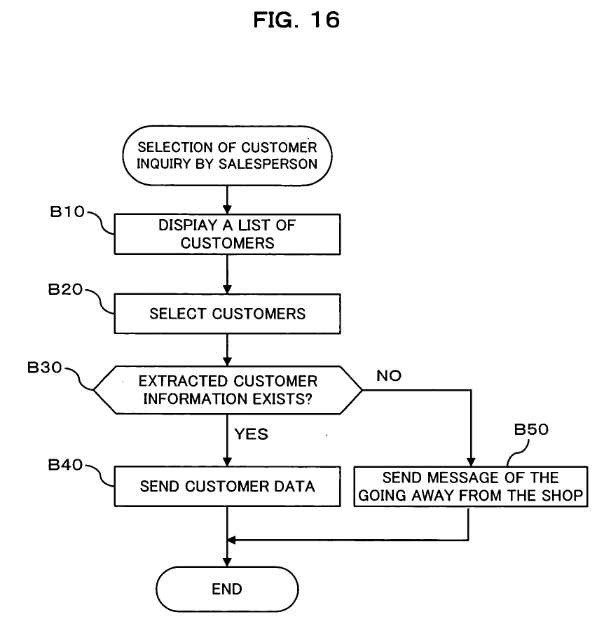

Next, with reference to a flowchart (step B 10 to B 50) shown in FIG. 16 description will be given of the method by which salespersons 70 are to have access to information on customers 41 in the customer service support system 1 according to one embodiment of the present invention.

When the salesperson 70 carrying the portable terminal 50 receives the notification regarding the coming of the customer 41 to the shop (refer to FIG. 8) from the notification section (management server 10), the salesperson 70 causes the touch panel 51 of the portable terminal 50 to display the screen for the selection of business types 51b (51a) and selects the customer inquiry business. Thereby on the touch panel 51 there is displayed the screen 51c (refer to FIG. 9) for the list of customers (step B10; priority setting step, display step), whereupon the salesperson 70 selects the specific customer 41 from among the customers 41 displayed in the list (step B20; selecting step).

The management server 10 judges whether there exists the extracted customer information on the selected customer 41 (step B 30), whereupon in case of existence of the extracted customer information (refer to YES route in step B 30) the management server 10 transmits the information on the customer 41 as customer inquiry screen 51d (refer to FIG. 10) to the portable terminal 50 of the salesperson 70(step B 40) and terminates the processing. Moreover in case of lack of the extracted customer information (refer to step B 30 NO route), a message indicating the going away from the shop is transmitted to the portable terminal 50 of the salesperson 70 (step B 50) and the processing is ended.

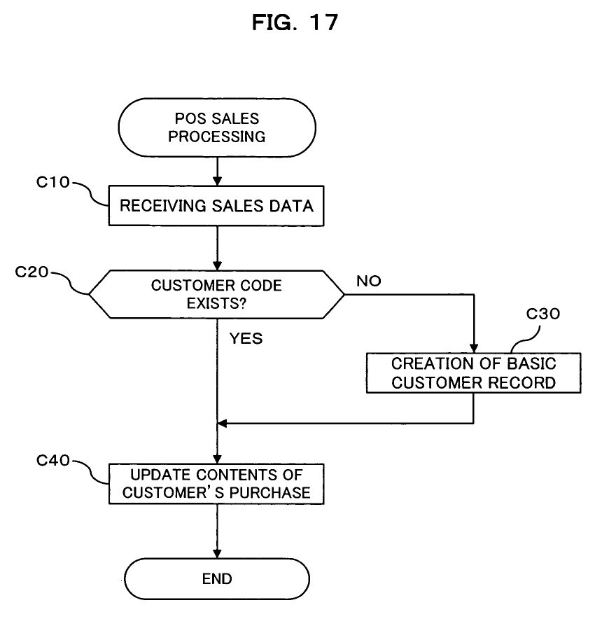

Next with reference to a flowchart (steps C 10 to C 40) shown in FIG. 17 description will be given of the processing in case of executing settlement processing at the POS terminal 60 in the customer service support system 1 according to one embodiment of the present invention.

When at the POS terminal 60 the customer 41 executes the settlement processing regarding shopping, there is to be transmitted the information on the settlement processing (customer code, purchase day, transaction number, total amount of money of transactions, total number of quantities of transactions, salesperson in charge, merchandise code, price of merchandise, quantity of merchandise and the like) from the POS terminal 60 to the management server 10 by way of the communication network 30, whereupon the management server 10 receives the information (sales data) (step C 10). The management server 10 acquires the customer code from the received information and judges whether there exists the purchase history information corresponding to the customer code in the customer DB 14 (step C 20).

In case of existence of the purchase history information corresponding to the customer code in the customer DB 14 (refer to YES route in step C 20) the management server 10 updates the purchase history information on the basis of the information on the settlement received from the POS terminal 60 (step C 40; customer information recording step) and the processing is ended. Now in case of lack of the purchase history information corresponding to the customer code in the customer DB 14 (refer to NO route in step C 20) the management server 10 creates newly a record of purchase history information on the customer 41 (step C 30) and the processing proceeds to step C 40.

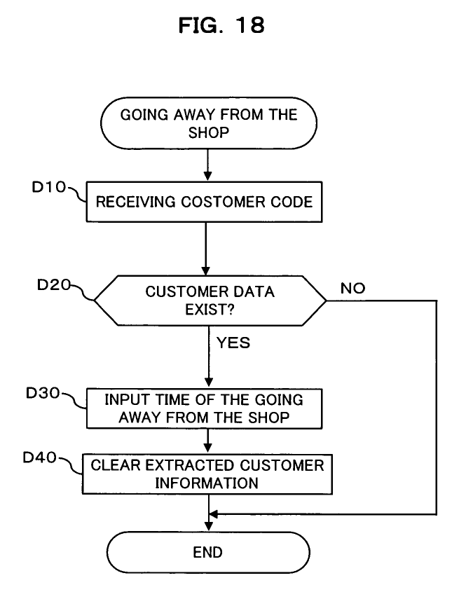

Next with reference to a flowchart (D 10 to D 40) shown in FIG. 18 description will be given of the processing at the time of the customer's going away from the shop in the customer service support system 1 according to one embodiment of the present invention.

When at the time of going away from the shop 100 of the customer 41 carrying the customer card 40 the card gate 20b provided in the vicinity of the exit 102 of the shop 100 receives the customer code registered in the customer card 40 (step D 10), the card gate 20b transmits the read-out customer code to the management server 10 by way of the communication network 30. Here when the customer 41 without the customer card 40 passed by the card gate 20b, the card gate 20 is unable to read-out the customer code of the customer 41.

The management server 10 (customer information acquisition section 11) having received the customer code judges whether there exists the detailed customer information corresponding to the customer code in the customer DB 14 (step D 20), whereupon in case of lack of the detailed customer information (refer to NO route in step D 20) the processing is ended.

Now on the other hand, in the case where there exists the detailed customer information corresponding to the customer code (refer to YES route in step D 20) in the customer DB 14, the management server 10 creates a record of information on the coming to the shop/the going away therefrom, and inputs date of the going away from the shop as well as time of the going away from the shop (step D 30).

The customer information acquisition section 11 clears extracted customer information corresponding to the customer code (step D40) and terminates the processing.

Thus in the customer service support system 1 according to one embodiment of the present invention, when the customer 41 carrying the customer card came to the shop 100, the card gate 20 reads-out the customer code recorded in the customer card and notify the management server 10, wherein this management server 10 (notifying section 12) notifies the person offering customer service to the effect pertaining thereto. Consequently the person offering customer service can acquire the knowledge of the customer 41 coming into the shop 100 quickly, so that great convenience as well as improved increase in satisfaction of the customer 41 capable of being subjected to customer service from the salesperson 70 can be achieved.

Further the notifying section 12 can notify the person 70 offering customer service of the fact that the customer 41 came to the shop, such that the notifying section 12 allows the touch panel 51 of the portable terminal 50 carried by each person 70 offering customer service to display messages, whereby it is made possible for the salesperson 70 to acquire the knowledge of the visit of the customer 41 to the shop quickly and certainly.

Still further the notifying section 12 can notify the person 70 offering customer service of the fact that the customer 41 came to the shop, such that the notifying section 12 allows the touch panel 51 allows to display as the screen 51c for the list of customers the list of a plurality of customers 41 staying in the shop 100, so that it is made possible for the salespersons 70 to grasp readily the state of customers 41 staying in the shop 100.

By allowing displaying the list for the display of the screen 51c for listed customers according to the rank of priority set in advance it is made possible for customers 41 with higher priority of importance to the shop 100 to be subjected to customer service in particular quickly, whereby great convenience can be achieved.

By allowing the salesperson 70 to select a specific customer 41 out of the screen 51c for listed customers it is made possible to have an access to the customer information, as customer inquiry screen 51d, on the customer 41, so that it is made possible for the salesperson 70 to acquire, prior to customer service, the pertinent information (e.g. the customer's purchase history or family make-up and the like), there enabling the optimum offering of customer service conforming to the customer 41. Moreover even in the event of absence of the salesperson 70 in charge it is made possible for a salesperson 70 other than the salesperson 70 in charge to acquire in advance the knowledge of the customer information, whereby there can be achieved the offering of customer service equivalent to that of the salesperson 70 in charge and improved increase in satisfaction of the customers.

Still further by setting rank or order of priority with which the customers are to be subjected to customer service to a plurality of customers 41 for each salesperson 70 and allowing displaying customer information according to the set priority it is made possible for the salesperson 70 to readily acquire the knowledge of the customers 41 with high priority, to whom customer service can be offered rapidly. Thus there is achieved a great convenience of importance to the salesperson 70 and also improved increase in satisfaction of the customers 41 with high priority.

By employing a contactless integrated circuit card as customer card 40 it is made possible to acquire customer code by way of the card gates 20a, 20b without attracting any attention of the customer 41, whereby great convenience can be achieved.

Furthermore by recording at least name of customers 41 for the salesperson 70 it is made possible to acquire the knowledge of name of customers 41, whereby there is achieved a great convenience as well as improved increase in satisfaction of the customers 41 of importance. Likewise by recording at least purchase history of customer 41 as customer information it is made possible for the salesperson 70 to acquire the knowledge of purchase history of customer 41 prior to the offering of customer service, so that the salespersons 70 do not suggest to the customers 41 any purchase of the merchandise and the like which the customers 41 already have, and can sell related merchandise and the like efficiently, whereby there is achieved a great convenience of importance to the salesperson 70 and also improved increase in satisfaction of the customers 41.

Further also by recording a face photo of customer 41 it is made possible for the salesperson 70 to acquire the knowledge of name of customer 41 prior to the offering of customer service, whereby there is achieved a great convenience of importance to the salesperson 70 and also improved increase in satisfaction of the customers 41.

Now the present invention is not limited to the afore-mentioned embodiments, and various modifications can be executed without departing from the spirit of the invention.

For example in connection with data types and data structure of data to be recorded in the customer DB 14 the present invention is not limited to the afore-mentioned embodiments and various modifications can be executed without departing from the spirit of the invention.

Furthermore when the notifying section made notification to the effect that the customer 41 came to the shop, the salesperson 70 may select/input customers 41 to be subjected to customer service of his/her own, from among the list of customers 41 displayed on the touch panel 51 (screen 51c for listed customers) and make it known to other salespersons 70, whereby it is made possible to divide the work of customer service among other salespersons 70 as to which customer is to be subjected to customer service, whereby there is achieved a great convenience. Moreover there is also improved increase in satisfaction of the customers 41 in that the customers 41 are not left alone without being subjected to customer service.

Furthermore according to the afore-mentioned embodiments only customer code is recorded in the customer card 40, however the invention is not limited to the afore-mentioned embodiments, and e.g. customer information (face photo, purchase history, family make-up and the like of the customer 41) may be recorded in the customer card 40. Namely the customer card 40 may be employed as customer information recording section.

Thus there is no need to the information in the customer DB 14 and there can be achieved simplification of the system as well as reduction of system and operating cost. The customer information can be shared with other systems provided independent of this customer service support system 1, whereby great convenience can be achieved.

By the way in the case where sharing of the customer information is to be carried out, there may be set security function in connection with part of the customer information (e.g. purchase history and the like) such as access authorization and the like and thus there may be achieved protection of information which is not desired to be disclosed to other shops and the like, whereby there can be achieved great convenience.

Note that as far as embodiments are disclosed, it is possible for a person having ordinary skill in the art to which the subject matter pertains.

Industrial Applicability

As stated above a system, a method, a device, and a program for supporting provision of customer service, and computer-readable recording medium according to the present invention are suitably applicable for supporting provision of customer service in customer service areas such as e.g. the ones of the shops and their utility is considered to be extremely high.

1. Customer service support system for supporting provision of customer service to be offered by a person offering customer service in customer service areas, comprising:
a medium capable of being carried by a customer and also intended to record customer specifying information for specifying the customer;
customer information recording section capable of recording customer information on the customer;
customer specifying information read-out section capable of reading-out the customer specifying information;
customer information acquisition section for acquiring, from said customer information recording section, the customer information on the customer, on the basis of the customer specifying information read-out by said customer specifying information read-out section;
a display section for displaying the customer information acquired by said customer information acquisition section;
a display control section for effecting a control allowing said display section to display the customer information acquired by said customer information acquisition section.

2. Customer service support system according to claim 1,
wherein there is provided, in the vicinity of the entrance of the customer service areas, said customer specifying information read-out section, which is intended to read out information recorded in said medium to be carried by the customer making entry into the customer service areas, and further there is provided a notifying section which, on reading out customer specifying information, notifies the person offering customer service of the customer having made entry into the customer service areas.

3. Customer service support system according to claim 1, wherein in the case where a plurality of customers are staying in the customer service area, said display control section is adapted to effect a control allowing said display section to display the list of at least part of customer information associated with the customers specified by the customer specifying information, from among the plurality of customers staying within the customer service area, and further there is provided a selecting section for allowing the person offering customer service to select customers to be subjected to customer service in association with the customer information from among the customers displayed in the list.

4. Customer service support system according to claim 1, wherein said medium is a contactless integrated circuit card.

5. Customer service support system according to claim 1, wherein said customer information is at least a name of customer and purchase history.

6. Customer service support system according to claim 1, wherein said medium functions as said customer information recording section.

7. Customer service support method of supporting provision of customer service to be offered by a person offering customer service in customer service areas, comprising the steps of:
a step of recording customer information on the customer;
a step of reading-out the customer specifying information from the medium intended to record customer specifying information for specifying the customer;
a step of customer information acquisition for acquiring said customer information on the customer recorded in the step of recording customer information, on the basis of the customer specifying information read-out in the customer specifying information read-out step;
a display step of displaying the customer information acquired in the customer information acquisition step.

8. Customer service support method according to claim 7, wherein the step of reading-out to the customer specifying information comprises reading-out the customer specifying information recorded in the medium to be carried by a customer making entry into customer service areas in the vicinity of the entrance of the customer service areas and further there is provided a notifying step of notifying the person offering customer service of the customer having made entry into customer service areas, on the occasion of the reading-out of the customer specifying information in the step of reading-out the customer specifying information.

9. Customer service support method according to claim 7, wherein the medium is a contactless integrated circuit card.

10. Customer service support method according to claim 7, wherein said customer information is at least a name of customer and purchase history.

11. Customer service support method according to claim 7, wherein the step of recording customer information customer comprises recording information on the customer in the medium.

12. Customer service support device for supporting provision of customer service to be offered by a person offering customer service in customer service areas, comprising:
customer information recording section capable of recording customer information on the customer;
customer information acquisition section for acquiring the customer information on the customer from said customer information recording section, on the basis of the customer specifying information for specifying the customer read-out from a medium capable of being carried by a customer;
a display control section for providing a control allowing the display section to display the customer information acquired by the customer information acquisition section.

13. Customer service support device according to claim 12, wherein there is provided a notifying section which, on occasion of entry of the customer into customer service areas, notifies the person offering customer service of the entry, having been made by the customer, into the customer service areas.

14. Customer service support device according to claim 12, wherein in the case where a plurality of customers are staying in the customer service area, said display control section is adapted to effect a control allowing said display section to display the list of at least part of customer information associated with the customers specified by the customer specifying information, from among the plurality of customers staying within the customer service area.

15. Customer service support device according to claim 12, wherein the medium is a contactless integrated circuit card.

16. Customer service support device according to claim 12, wherein said customer information is at least a name of customer and purchase history.

17. A computer-readable recording medium which stores a customer service support program for causing a computer to execute a function of supporting customer service to be offered by a person offering customer service in customer service areas, said program causing a computer to function as the following sections, said sections comprising:
customer information acquisition section for acquiring, the customer information on the customer from a customer information recording section, on the basis of the customer specifying information read-out from a medium capable of being carried by the customer;
a display control section for effecting a control allowing the display section to display the customer information acquired by the customer information acquisition section.

18. A computer-readable recording medium which stores a customer service support program according to claim 17, wherein the program causes a computer to function as a notifying section which, on occasion of the entry, having been made by the customer, into customer service areas, notifies the person offering customer service of the customer having made entry into the customer service areas.

19. A computer-readable recording medium which stores a customer service support program according to claim 17, wherein the program instructs the computer in a case where a plurality of customers are staying in the customer service area, to function as said display control section which effects a control allowing said display section to display the list of at least part of customer information associated with the plurality of customers staying within the customer service area.

20. Portable terminal device for supporting provision of customer service to be offered by a person offering customer service in customer service areas, comprising:
a receiving means for receiving customer information on the customer;
a display means for displaying customer information;
a display control means for effecting a control allowing said display means to display the customer information received by said receiving means.
